(19) United States
(12) Patent Application Publication
(10) Pub. No.: US 2026/0287945 A1
(43) Pub. Date: Sep. 24, 2026

(54) DISPLAY PANEL AND DISPLAY DEVICE

(71) Applicants: Chongqing BOE Optoelectronics Technology Co., Ltd., Chongqing (CN); BOE Technology Group Co., Ltd., Beijing (CN)

(72) Inventors: Bin WAN, Beijing (CN); Xiaoyuan WANG, Beijing (CN); Hui GUO, Beijing (CN); Junming CHEN, Beijing (CN); Guodong YANG, Beijing (CN); Yuanyuan ZHU, Beijing (CN)

(21) Appl. No.: 18/881,258

(22) PCT Filed: Feb. 6, 2024
(86) PCT No.: PCT/CN2024/076358

§ 371 Date: Jan. 3, 2025

(30) Foreign Application Priority Data
Mar. 24, 2023 (CN) 202310301155.8

(51) Int. Cl. G02F 1/1335; G02F 1/1339

(52) U.S. Cl. CPC G02F 1/133512; G02F 1/133514; G02F 1/1339

(57) ABSTRACT

A display panel and a display device are provided. The display panel includes: a first substrate; a second substrate arranged opposite the first substrate and a black matrix on a side of the second substrate facing the first substrate. An outer edge of the black matrix is flush with an outer edge of the second substrate.

### CROSS-REFERENCE TO RELATED APPLICATION

This application is a national phase entry under 35 U.S.C. § 371 of International Application No. PCT/CN2024/076358, filed on Feb. 6, 2024, which claims priority to Chinese Patent Application No. 202310301155.8, filed with the China National Intellectual Property Administration on Mar. 24, 2023 and entitled “Display Panel and Display Device”, the entire contents of which are incorporated herein by reference.

### TECHNICAL FIELD

The present invention relates to the field of semiconductor technology, and in particular to a display panel and a display device.

### BACKGROUND

With the development of information technology, electronic devices are widely used in people's daily lives. Liquid crystal displays, as the most widely used flat panel displays, occupy an important position in display panels. With the increasing demand of customers in the market, requirements for display quality and reliability of displays are also becoming increasingly higher.

### SUMMARY

Embodiments of the present disclosure provide a display panel, including:
a first substrate;
a second substrate, arranged opposite to the first substrate;
a black matrix, located on a side of the second substrate facing the first substrate.

An outer edge of the black matrix is flush with an outer edge of the second substrate.

In some embodiments, the display panel is provided with a display area and a non-display area outside the display area.

The black matrix is provided in the non-display area with at least one black matrix groove structure surrounding the display area.

In some embodiments, the display panel further includes: a frame sealant disposed between the first substrate and the second substrate and located in the non-display area.

The black matrix groove structure includes: a first black matrix groove structure surrounding the display area. An orthographic projection of the frame sealant on the second substrate covers an orthographic projection of the first black matrix groove structure on the second substrate.

In some embodiments, the first substrate is provided with a metal wiring in the non-display area.

The black matrix groove structure further includes: a second black matrix groove structure surrounding the display area. The first black matrix groove structure surrounds the second black matrix groove structure. An orthographic projection of the metal wiring on the second substrate covers an orthographic projection of the second black matrix groove structure on the second substrate.

In some embodiments, the metal wiring includes: a common electrode lead.

In some embodiments, the second substrate is provided with a first color filter portion and a second color filter portion in the non-display area.

An orthographic projection of the first color filter portion on the second substrate covers the orthographic projection of the first black matrix groove structure on the second substrate. An orthographic projection of the second color filter portion on the second substrate covers the orthographic projection of the second black matrix groove structure on the second substrate.

In some embodiments, the second substrate is further provided with a third color filter portion in the display area.

The second color filter portion and the third color filter portion are an integrated and connected structure.

In some embodiments, the first color filter portion, the second color filter portion, and the third color filter portion are all blue color filter portions.

In some embodiments, a depth of the black matrix groove structure is equal to a thickness of the black matrix.

In some embodiments, the first substrate is provided with: a first electrode layer, a second electrode layer, and an insulating layer between the first electrode layer and the second electrode layer. The insulating layer is provided with an insulating layer groove structure in the non-display area. The insulating layer groove structure at different positions of the display panel is an integrated and connected structure.

In some embodiments, at least a portion of an outer edge of the insulating layer groove structure away from the display area is located in a region outside an outer edge of the frame sealant away from the display area.

In some embodiments, the first substrate is further provided with a first alignment film on a side of the insulating layer facing the second substrate. In at least a portion of the non-display area, the alignment film covers the insulating layer groove structure and contacts the first substrate.

In some embodiments, an orthographic projection of an inner edge of the insulating layer groove structure facing the display area on the first substrate is within an orthographic projection of the frame sealant on the first substrate.

In some embodiments, an orthographic projection of the insulating layer groove structure on the first substrate at a corner position of the display panel is an arc shape.

Embodiments of the present disclosure further provide a display device, which includes the display panel provided by the embodiments of the present disclosure.

### BRIEF DESCRIPTION OF DRAWINGS

FIG. 1 is a schematic cross-sectional view of a display panel according to an embodiment of the present disclosure.

FIG. 2A is a first schematic top view of a display panel according to an embodiment of the present disclosure.

FIG. 2B is a schematic diagram of the film layers except the insulating layer in FIG. 2A.

FIG. 2C is a schematic diagram of a single film layer of the black matrix layer in FIG. 2A.

FIG. 2D is a schematic diagram of a film layer of a metal wiring in FIG. 2A.

FIG. 3A is a second schematic top view of a display panel according to an embodiment of the present disclosure.

FIG. 3B is a schematic diagram of the film layers except the insulating layer in FIG. 3A.

FIG. 3C is a schematic diagram of a single film layer of the black matrix layer in FIG. 3A.

FIG. 3D is a schematic diagram of a film layer of a metal wiring in FIG. 3A.

FIG. 4 is a schematic diagram of a projection relationship between a first black matrix groove structure and an outer edge of a first color filter portion according to an embodiment of the present disclosure.

### DETAILED DESCRIPTION

In order to make the purpose, technical solution and advantages of the embodiments of the present invention more clear, the technical solution of the embodiments of the present invention will be clearly and completely described below in conjunction with the accompanying drawings of the embodiments of the present invention. It should be noted that the size and shape of each figure in the accompanying drawings do not reflect the actual proportion, and the purpose is only to illustrate the content of the present invention. And the same or similar reference numerals throughout represent the same or similar elements or elements having the same or similar functions. Obviously, the described embodiments are only part of the embodiments of the present invention, rather than all the embodiments. Based on the described embodiments of the present invention, all other embodiments obtained by those of ordinary skill in the art without creative work are within the scope of protection of the present invention.

Unless otherwise defined, technical or scientific terms used herein shall have the general meaning as commonly understood by those of ordinary skill in the art to which the invention belongs. The words “first”, “second” and similar terms used in the specification and claims of the present invention do not indicate any order, quantity or importance, but are only used to distinguish different components. The words “include” or “comprise” and the like mean that the elements or objects preceding the word include the elements or objects listed after the word and their equivalents, but do not exclude other elements or objects. “Inside”, “outside”, “upper”, “lower”, etc. are only used to indicate relative position relationships. When the absolute position of the object being described changes, the relative position relationship may also change accordingly.

As used herein, “about” or “substantially the same” is inclusive of the stated value and means within an acceptable range of deviation for the particular value as determined by those of ordinary skill in the art taking into account the measurement in question and errors associated with the measurement for the particular value (i.e., the limitations of the measurement system). For example, “substantially the same” means within one or more standard deviations, or within ±30%, 20%, 10%, 5% relative to the stated value.

In the drawings, the thickness of layers, films, panels, regions, etc., are exaggerated for clarity. Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shapes of the regions and are not intended to limit the scope of the claims.

In order to keep the following description of the embodiments of the present disclosure clear and concise, the present disclosure omits detailed descriptions of well-known functions and well-known components.

In existing product design solutions, the display panel has the problem of light leakage at the edge with a large viewing angle at the client side.

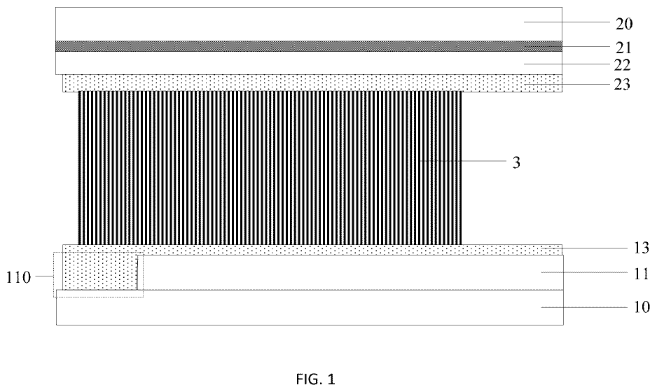

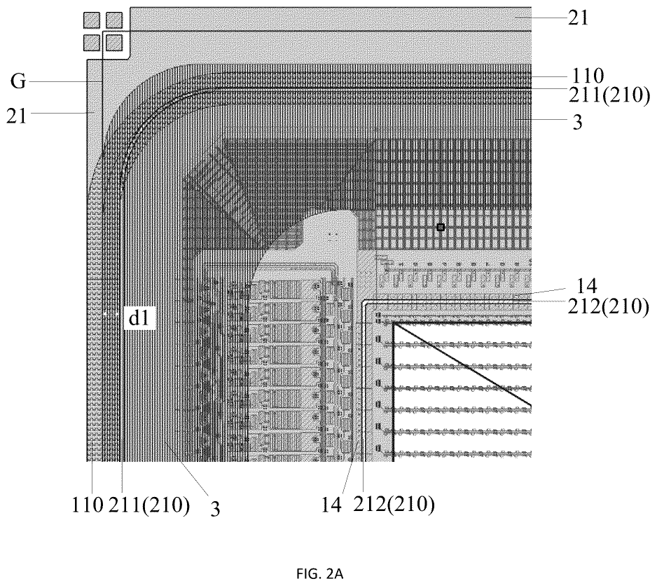

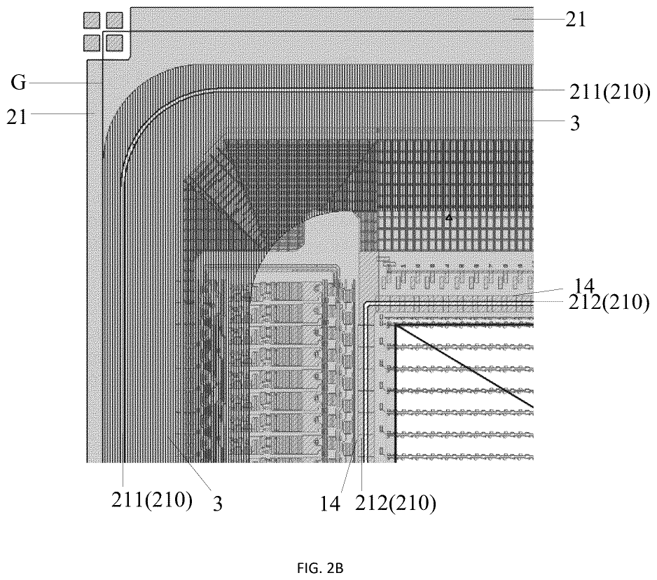

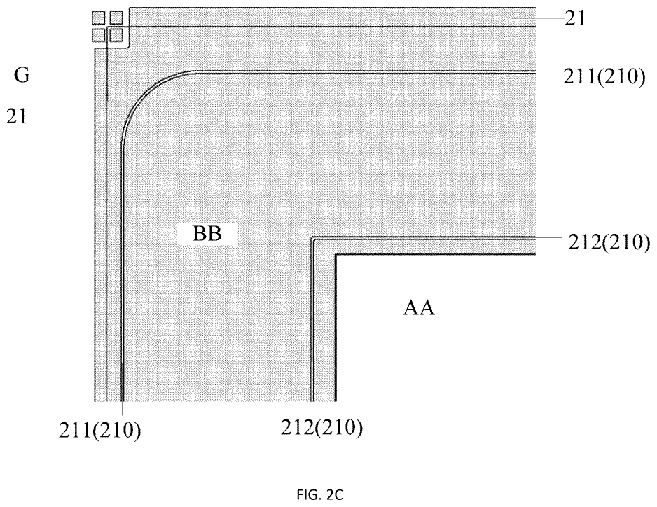

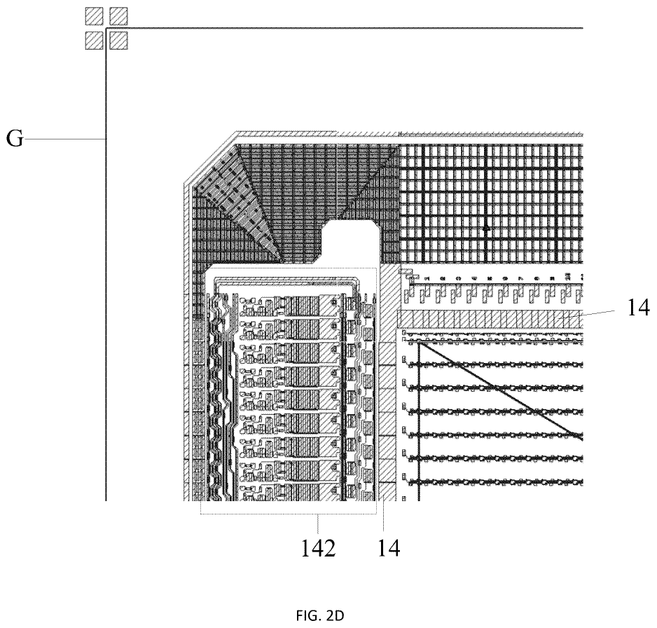

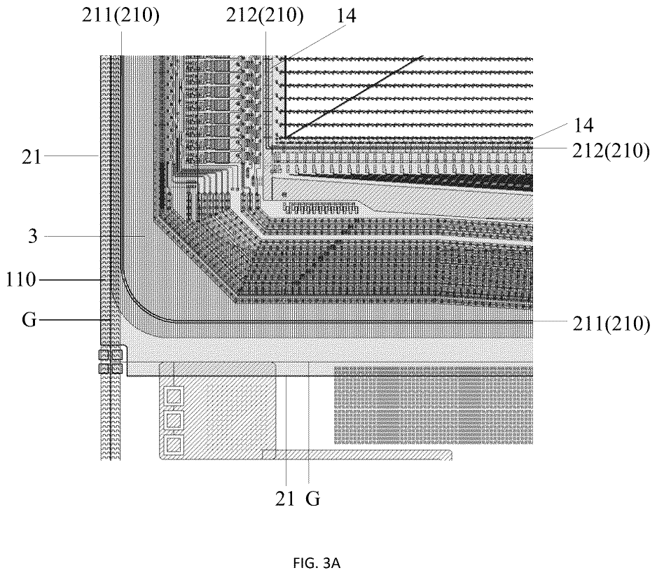

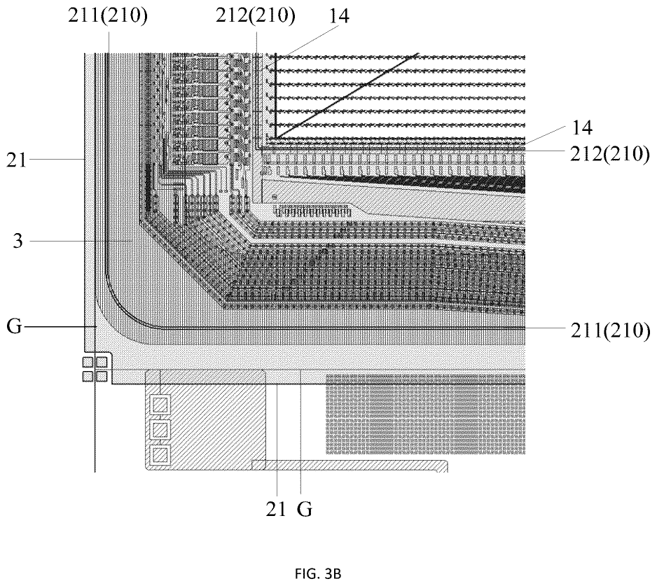

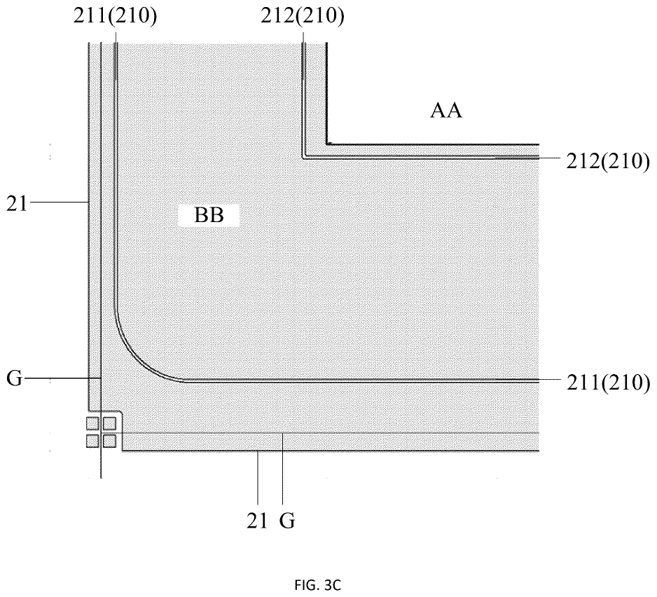

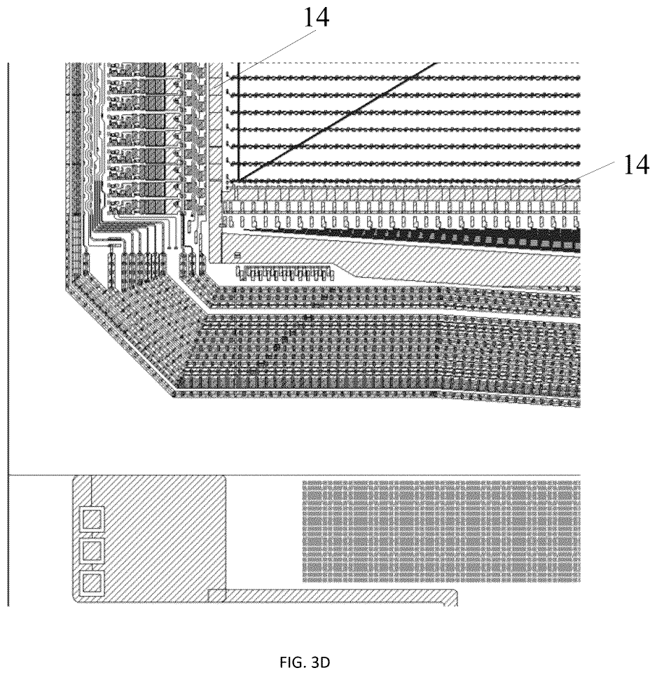

In view of this, embodiments of the present disclosure provide a display panel, as shown in FIG. 1, FIG. 2A-FIG. 2D, and FIG. 3A-FIG. 3D. FIG. 2B is a schematic diagram of film layers except the insulating layer in FIG. 2A. FIG. 2C is a schematic diagram of a single film layer of the black matrix layer in FIG. 2A. FIG. 2D is a schematic diagram of a film layer of metal wiring in FIG. 2A. FIG. 3B is a schematic diagram of film layers except the insulating layer in FIG. 3A. FIG. 3C is a schematic diagram of a single film layer of the black matrix layer in FIG. 3A. FIG. 3D is a schematic diagram of a film layer of metal wiring in FIG. 3A. FIG. 2A-FIG. 2D are schematic diagrams of an upper corner of the display panel. FIG. 3A-FIG. 3D are schematic diagrams of a lower corner of the display panel. G represents a cutting line when forming the display panel. The display panel includes:
a first substrate 10;
a second substrate 20 arranged opposite to the first substrate 10; and
a black matrix 21 on a side of the second substrate 20 facing the first substrate 10.

An outer edge of the black matrix 21 is flush with an outer edge of the second substrate 20.

In disclosed embodiments, the outer edge of the black matrix 21 is flush with the outer edge of the second substrate 20, that is, the black matrix 21 is designed to be flush on all four sides. After the display panel is cut, the black matrix 21 on all four sides is flush with the cutting line G, which can avoid the problem of light leakage at the edge of the display panel with a large viewing angle at the client side when the black matrix 21 is not designed to be flush.

In some embodiments, referring to FIG. 2C and FIG. 3C, the display panel has a display area AA and a non-display area BB located outside the display area AA. The black matrix 21 is provided with at least one black matrix groove structure 210 surrounding the display area AA in the non-display area BB. In disclosed embodiments, the black matrix 21 is provided with at least one black matrix groove structure 210 surrounding the display area AA in the non-display area BB, so as to prevent static electricity generated by cutting from being introduced into the display panel along the black matrix 21 and affecting the display of the display panel.

In some embodiments, referring to FIGS. 1, 2A-2D, and 3A-3D, the display panel further includes: a frame sealant 3 disposed between the first substrate 10 and the second substrate 20 and located in the non-display area BB. The black matrix groove structure 210 includes: a first black matrix groove structure 211 surrounding the display area AA. The orthographic projection of the frame sealant 3 on the second substrate 20 covers the orthographic projection of the first black matrix groove structure 211 on the second substrate 20. In disclosed embodiments, the orthographic projection of the frame sealant 3 on the second substrate 20 covers the orthographic projection of the first black matrix groove structure 211 on the second substrate 20, which can further prevent static electricity generated by cutting from being introduced into the display panel along the black matrix 21 during cutting and affecting the display of the display panel.

In some embodiments, referring to FIG. 2A, in order to ensure that the first black matrix groove structure 211 is completely covered by the frame sealant 3, the distance d1 from the orthographic projection of the outer edge of the first black matrix groove structure 211 on the second substrate 20 to the orthographic projection of the outer edge of the frame sealant 3 on the second substrate 20 is ≥1/2d2+d3. Here, d2 represents the width of the frame sealant 3 in a direction perpendicular to the extension direction of the frame sealant 3, and d3 represents the sealant coating accuracy (in the process of applying the frame sealant 3 in practice, the sealant coating equipment cannot completely and accurately apply the sealant at the specified position, and there is a sealant coating deviation, that is, the sealant coating accuracy, for example, the sealant coating accuracy may be 70 μm).

For example, the width of the black matrix groove structure 210 in a direction perpendicular to the extension direction of the black matrix groove structure 210 may be 15 μm to 25 μm. For example, the width of the black matrix groove structure 210 in a direction perpendicular to the extending direction of the black matrix groove structure 210 may be 20 μm.

In some embodiments, referring to FIGS. 2A-2D and 3A-3D, the first substrate 10 is provided with a metal wiring 14 in the non-display area BB. The black matrix groove structure 210 further includes: a second black matrix groove structure 212 surrounding the display area AA. The first black matrix groove structure 211 surrounds the second black matrix groove structure 212. The orthographic projection of the metal wiring 14 on the second substrate 20 covers the orthographic projection of the second black matrix groove structure 212 on the second substrate 20. In disclosed embodiments, the black matrix groove structure 210 further includes a second black matrix groove structure 212, which can further prevent static electricity generated during cutting from being introduced into the interior of the display panel along the black matrix 21. The orthographic projection of the metal wiring 14 on the second substrate 20 covers the orthographic projection of the second black matrix groove structure 212 on the second substrate 20, which can prevent light leakage from the second black matrix groove structure 212.

In some embodiments, referring to FIGS. 2A-2D and 3A-3D, the metal wiring 14 may include: a common electrode lead. The common electrode lead may be an existing wiring in the display panel. In disclosed embodiments, a second black matrix groove structure 212 is provided at the position of the existing common electrode lead of the display panel. While light blocking is achieved for the second black matrix groove structure 212, the manufacturing process of the display panel is simplified.

In a possible embodiment, the second substrate 20 is further provided with a first color filter portion (not shown in the drawings) and a second color filter portion (not shown in the drawings) in the non-display area BB. The orthographic projection of the first color filter portion on the second substrate 20 covers the orthographic projection of the first black matrix groove structure 211 on the second substrate 20. The orthographic projection of the second color filter portion on the second substrate 20 covers the orthographic projection of the second black matrix groove structure 212 on the second substrate 20. In embodiments of the present disclosure, the orthographic projection of the first color filter portion on the second substrate 20 covers the orthographic projection of the first black matrix groove structure 211 on the second substrate 20, and the orthographic projection of the second color filter portion on the second substrate 20 covers the orthographic projection of the second black matrix groove structure 212 on the second substrate 20, which can reduce the transmittance at the positions of the first black matrix groove structure 211 and the second black matrix groove structure 212.

In some embodiments, the second substrate 20 is further provided with a third color filter portion (not shown in the drawings) in the display area AA. The second color filter portion and the third color filter portion are an integrated and connected structure. In disclosed embodiments, the second color filter portion and the third color filter portion are an integrated and connected structure. The second color filter portion is formed integrally while the third color filter portion is formed in the display area AA, which can simplify the manufacturing process of the second color filter portion. For example, the orthographic projection of the second color filter portion on the second substrate 20 does not overlap with the orthographic projection of color filter portions, of colors other than the color of the third color filter portion, in the display area AA on the second substrate 20. For example, the third color filter portion is a blue color filter. The orthographic projection of the second color filter portion on the second substrate 20 does not overlap with the orthographic projection of the red color filter portion and the green color filter portion in the display area AA on the second substrate 20.

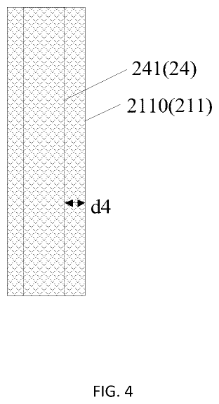

In a possible embodiment, the first color filter portion and the third color filter portion are independent structures that are not connected to each other. For example, referring to FIG. 4, in order to minimize the transmittance at the position of the first black matrix groove structure 211, the first black matrix groove structure 211 is completely covered by the first color filter portion 24. The distance d4 between the orthographic projection of the outer edge 241 of the first color filter portion 24 on the second substrate 20 and the orthographic projection of the outer edge 2110 of the first black matrix groove structure 211 on the second substrate 20 is greater than or equal to 15 μm.

In some embodiments, the first color filter portion, the second color filter portion, and the third color filter portion are all blue color filter portions. In disclosed embodiments, since the blue color filter portion has a smaller light transmittance, the first color filter portion and the second color filter portion are both blue color filter portions, which have a better light shielding effect.

In some embodiments, the depth of the black matrix groove structure 210 is equal to the thickness of the black matrix 21. Compared with the black matrix groove structure 210 which is a half groove that does not penetrate the black matrix 21 and needs to be produced by a half-tone mask plate, which has a higher production cost, in embodiments of the present disclosure, the black matrix groove structure 210 is a through groove that penetrates the black matrix 21. While avoiding the introduction of static electricity, it can also simplify the production process of the black matrix groove structure 210 and reduce the production cost of the display panel.

For example, as shown in FIG. 1, the second substrate 20 may further be provided with a planarization layer 22 on the side of the black matrix 21 facing the first substrate 10, and a second alignment film 23 on the side of the planarization layer 22 facing away from the black matrix 21.

In some embodiments, referring to FIGS. 1, 2A-2D, and 3A-3D, the first substrate 10 is further provided with: a first electrode layer, a second electrode layer, and an insulating layer 11 between the first electrode layer and the second electrode layer. The insulating layer 11 is provided with an insulating layer groove structure 110 in the non-display area BB. The insulating layer groove structure 110 at different positions of the display panel is an integrated and connected structure. Compared with the disconnected insulating layer groove structure 110, in embodiments of the present disclosure, the insulating layer groove structure 110 at different positions of the display panel is an integrated and connected structure, which can alleviate the display problem of the display panel caused by water vapor intrusion under high temperature and high humidity reliability conditions. For example, the display panel has a first side for binding with the circuit board, and a second side other than the first side. The insulating layer groove structure 110 on the second side of the display panel is an integrated and connected structure. For example, as shown in FIG. 3A, the lower side of the display panel is the first side for binding with the circuit board. The upper side, left side and right side of the display panel are the second sides. The insulating layer groove structure 110 of the upper side, left side and right side of the display panel is an integrated and connected structure.

In some embodiments, the first electrode layer may be a pixel electrode layer, and the second electrode layer may be a common electrode layer. The second electrode layer is on a side of the first electrode layer away from the first substrate 10. For example, the first substrate 10 may be further provided with a gate layer, an active layer, and a data line layer in sequence on the side facing the second substrate 20. The gate layer, the active layer, and the data line layer are all located on the side of the first electrode layer facing away from the second electrode layer. That is, when manufacturing a display panel, the gate layer, the active layer, the data line layer, the first electrode layer, the insulating layer, and the second electrode layer may be formed in sequence on one side of the first substrate 10.

For example, the common electrode lead can provide a signal for the second electrode layer. The common electrode lead can be located at a layer different from the second electrode layer. For example, the common electrode lead can be provided in the same layer as the gate layer.

In some embodiments, referring to FIG. 1, FIG. 2A-FIG 2D, and FIG. 3A-FIG 3D, at least a portion of the outer edge of the insulating layer groove structure 110 away from the display area AA is located outside the outer edge of the frame sealant 3 away from the display area AA. For example, as shown in FIG. 2A, the outer edge of the insulating layer groove structure 110 at the left side in FIG. 2A is located outside the outer edge of the frame sealant 3 away from the display area AA.

In some embodiments, referring to FIG. 1, 2A-2D, and 3A-3D, the first substrate 10 is further provided with a first alignment film 13 on a side of the insulating layer 11 facing the second substrate 20. In at least a portion of the non-display area BB, the first alignment film 13 covers the insulating layer groove structure 110 and contacts the first substrate 10. In embodiments of the present disclosure, at least part of the outer edge of the insulating layer groove structure 110 away from the display area AA is located in a region outside the outer edge of the frame sealant 3 away from the display area AA. The first alignment film 13 covers the insulating layer groove structure 110 and contacts the first substrate 10. That is, after the insulating layer 11 is grooved, during the box forming process, at the position where the insulating layer groove structure 110 is not covered by the frame sealant 3, the first alignment film 13 (for example, the material may be polyimide) may directly contact the first substrate 10 (for example, a glass substrate). Since the adhesion between the first alignment film 13 and the glass substrate is much greater than the adhesion between the first alignment film 13 and the insulating layer 11, water vapor can be prevented from entering the interior of the display panel along the contact interface between the first alignment film 13 and the insulating layer 11, thereby preventing water vapor from corroding the via hole of the gate drive unit GOA (as shown in the dotted box 142 in FIG. 2D) inside the display panel, thereby solving the display-related defects caused by water vapor corrosion.

For example, the first substrate 10 may be a rigid substrate, for example, a glass substrate.

In some embodiments, referring to FIG. 1, FIG. 2A-FIG. 2D, and FIG. 3A-FIG. 3D, the orthographic projection of the inner edge of the insulating layer groove structure 110 facing the display area AA on the first substrate 10 is located within the orthographic projection of the frame sealant 3 on the first substrate. In disclosed embodiments, the frame sealant 3 completely covers the inner edge of the insulating layer groove structure 110 (for example, the width of the insulating layer groove structure 110 in the frame sealant may be greater than or equal to 100 μm), which can prevent water vapor from entering to the greatest extent.

In some embodiments, referring to FIGS. 2A to 2D and FIGS. 3A to 3D, the orthographic projection of the insulating layer groove structure 110 on the first substrate 10 at the corner position of the display panel is an arc shape. In disclosed embodiments, the orthographic projection of the insulating layer groove structure 110 on the first substrate 10 at the corner of the display panel is an arc shape. That is, at the corner, the insulating layer groove structure 110 is connected by the design of an arc angle, so that the insulating layer groove structure 110 is connected as a whole, avoiding the occurrence of weak interfaces.

Based on the same inventive concept, embodiments of the present disclosure further provide a display device, which includes a display panel provided by the embodiments of the present disclosure. The display device may be any product or component with a display function, such as a mobile phone, a tablet computer, a television, a monitor, a laptop computer, a digital photo frame, a navigator, a smart watch, a fitness wristband, a personal digital assistant, etc. Other essential components of the display device are well understood by those of ordinary skill in the art and will not be described in detail herein and should not be construed as limiting the present invention. In addition, since the principle of solving the problem by the display device is similar to the principle of solving the problem by the above-mentioned display panel, the implementation of the display device can refer to the implementation of the above-mentioned liquid crystal display panel, and the repeated description will be omitted.

Although preferred embodiments of the present invention have been described, additional changes and modifications may occur to these embodiments once those skilled in the art are aware of the basic inventive concepts. Therefore, it is intended that the appended claims be interpreted as including the preferred embodiment as well as all changes and modifications that fall within the scope of the present invention.

Obviously, those skilled in the art can make various changes and modifications to the embodiments of the present invention without departing from the spirit and scope of the embodiments of the present invention. Thus, if these modifications and variations of the embodiments of the present invention fall within the scope of the claims of the present invention and their equivalents, the present invention is also intended to include these modifications and variations.

1. A display panel, comprising:
a first substrate;
a second substrate, arranged opposite to the first substrate;
a black matrix, on a side of the second substrate facing the first substrate;
wherein an outer edge of the black matrix is flush with an outer edge of the second substrate.

2. The display panel according to claim 1, wherein the display panel is provided with a display area and a non-display area outside the display area;
the black matrix is provided in the non-display area with at least one black matrix groove structure surrounding the display area.

3. The display panel according to claim 2, further comprising:
a frame sealant disposed between the first substrate and the second substrate and located in the non-display area;
wherein the black matrix groove structure comprises:
a first black matrix groove structure surrounding the display area;
wherein an orthographic projection of the frame sealant on the second substrate covers an orthographic projection of the first black matrix groove structure on the second substrate.

4. The display panel according to claim 3, wherein the first substrate is provided with a metal wiring in the non-display area;
the black matrix groove structure further comprises:
a second black matrix groove structure surrounding the display area;
wherein the first black matrix groove structure surrounds the second black matrix groove structure; and an orthographic projection of the metal wiring on the second substrate covers an orthographic projection of the second black matrix groove structure on the second substrate.

5. The display panel according to in claim 4, wherein the metal wiring comprises: a common electrode lead.

6. The display panel according to claim 4, wherein the second substrate is provided with a first color filter portion and a second color filter portion in the non-display area;
an orthographic projection of the first color filter portion on the second substrate covers the orthographic projection of the first black matrix groove structure on the second substrate; an orthographic projection of the second color filter portion on the second substrate covers the orthographic projection of the second black matrix groove structure on the second substrate.

7. The display panel according to claim 6, wherein the second substrate is further provided with a third color filter portion in the display area;
the second color filter portion and the third color filter portion are an integrated and connected structure.

8. The display panel according to claim 7, wherein the first color filter portion, the second color filter portion, and the third color filter portion are all blue color filter portions.

9. The display panel according to claim 2, wherein a depth of the black matrix groove structure is equal to a thickness of the black matrix.

10. The display panel according to claim 3, wherein the first substrate is provided with: a first electrode layer, a second electrode layer, and an insulating layer between the first electrode layer and the second electrode layer;
the insulating layer is provided with an insulating layer groove structure in the non-display area, and the insulating layer groove structure at different positions of the display panel is an integrated and connected structure.

11. The display panel according to claim 10, wherein at least a portion of an outer edge of the insulating layer groove structure away from the display area is located in a region outside an outer edge of the frame sealant away from the display area.

12. The display panel according to claim 10, wherein the first substrate is further provided with a first alignment film on a side of the insulating layer facing the second substrate;
in at least a portion of the non-display area, the alignment film covers the insulating layer groove structure and contacts the first substrate.

13. The display panel according to claim 10, wherein an orthographic projection of an inner edge of the insulating layer groove structure facing the display area on the first substrate is within an orthographic projection of the frame sealant on the first substrate.

14. The display panel according to claim 10, wherein an orthographic projection of the insulating layer groove structure on the first substrate at a corner position of the display panel is an arc shape.

15. A display device, comprising a display panel, wherein the display panel comprises:
a first substrate;
a second substrate, arranged opposite to the first substrate;
a black matrix, on a side of the second substrate facing the first substrate;
wherein an outer edge of the black matrix is flush with an outer edge of the second substrate.

16. The display device according to claim 15, wherein the display panel is provided with a display area and a non-display area outside the display area;
the black matrix is provided in the non-display area with at least one black matrix groove structure surrounding the display area.

17. The display device according to claim 16, wherein the display panel further comprises:
a frame sealant disposed between the first substrate and the second substrate and located in the non-display area;
wherein the black matrix groove structure comprises:
a first black matrix groove structure surrounding the display area;
wherein an orthographic projection of the frame sealant on the second substrate covers an orthographic projection of the first black matrix groove structure on the second substrate.

18. The display device according to claim 17, wherein the first substrate is provided with a metal wiring in the non-display area;
the black matrix groove structure further comprises:
a second black matrix groove structure surrounding the display area;
wherein the first black matrix groove structure surrounds the second black matrix groove structure; and an orthographic projection of the metal wiring on the second substrate covers an orthographic projection of the second black matrix groove structure on the second substrate.

19. The display device according to claim 17, wherein the first substrate is provided with: a first electrode layer, a second electrode layer, and an insulating layer between the first electrode layer and the second electrode layer;
the insulating layer is provided with an insulating layer groove structure in the non-display area, and the insulating layer groove structure at different positions of the display panel is an integrated and connected structure.

20. The display device according to claim 19, wherein the first substrate is further provided with a first alignment film on a side of the insulating layer facing the second substrate;
in at least a portion of the non-display area, the alignment film covers the insulating layer groove structure and contacts the first substrate.
